(19) United States
(12) Patent Application Publication
(10) Pub. No.: US 2024/0429519 A1
(43) Pub. Date: Dec. 26, 2024

(54) BATTERY PACK

(71) Applicant: Prime Planet Energy & Solutions, Inc., Tokyo (JP)

(72) Inventor: Shinobu TERAUCHI, Kasai-shi (JP)

(21) Appl. No.: 18/677,878

(22) Filed: May 30, 2024

(30) Foreign Application Priority Data
Jun. 26, 2023 (JP) 2023-104397

(51) Int. Cl. H01M 50/242; H01M 50/367

(52) U.S. Cl. CPC H01M 50/242; H01M 50/367

(57) ABSTRACT

A battery pack includes: a plurality of battery cells; a case main body provided with an opening; a cover that is attached to the case main body so as to close the opening and that forms, together with the case main body, a space for accommodating the plurality of battery cells; and a plate member having a first portion and a second portion, the first portion being disposed between each of the plurality of battery cells and the cover in the space, the second portion being provided at a peripheral edge of the first portion, the second portion being sandwiched by the case main body and the cover, the plate member being composed of a metal or ceramic.

### CROSS REFERENCE TO RELATED APPLICATIONS

This nonprovisional application is based on Japanese Patent Application No. 2023-104397 filed on Jun. 26, 2023 with the Japan Patent Office, the entire contents of which are hereby incorporated by reference.

### BACKGROUND OF THE INVENTION

### Field of the Invention

The present invention relates to a battery pack.

### Description of the Background Art

For example, WO 2020/189590 discloses a battery pack including: a secondary battery; a housing that accommodates the secondary battery; and a plate-shaped reinforcing portion that extends from one end to the other end of the housing in a long-side direction thereof and that is disposed in a height direction of the secondary battery so as to reinforce the housing.

Further, Japanese National Patent Publication No. 2021-535556 discloses a battery pack including: a cell; a first panel and a second panel respectively connected to an upper surface and a lower surface of the cell; and a heat conduction plate provided between the cell and the first panel.

### SUMMARY OF THE INVENTION

In the above-described battery pack disclosed in WO 2020/189590, the housing (case) that accommodates the secondary battery is constituted of: a main body portion having a rectangular box shape, the main body portion being opened at its upper portion; and a cover that covers the opening of the main body portion. In such a battery pack, there is such a concern that when combustible high-pressure gas is generated from a battery cell in response to occurrence of battery abnormality or when spontaneous ignition occurs due to the generation of such high-pressure gas, the gas is leaked from between the main body portion and the cover or the cover is damaged by the gas or a shock wave caused by the spontaneous ignition.

Therefore, it is an object of the present invention to solve the above-described problem and to provide a battery pack to prevent leakage of gas and damage of a cover by a simple configuration.
[1] A battery pack comprising: a plurality of battery cells; a case main body provided with an opening; a cover that is attached to the case main body so as to close the opening and that forms, together with the case main body, a space for accommodating the plurality of battery cells; and a plate member having a first portion and a second portion, the first portion being disposed between each of the plurality of battery cells and the cover in the space, the second portion being provided at a peripheral edge of the first portion, the second portion being sandwiched by the case main body and the cover, the plate member being composed of a metal or ceramic.

According to the battery pack thus configured, since gas generated from a battery cell or a shock wave caused by spontaneous ignition is received by the first portion of the plate member, damage of the cover can be prevented, and since the space between the case main body and the cover is sealed by the second portion of the plate member, leakage of the gas can be prevented. In such a configuration, since the first portion and the second portion are integrally provided in the plate member, the damage of the cover and the leakage of gas can be prevented by such a simple configuration.
[2] The battery pack according to [1], wherein each of the battery cells has: an exterior package that includes a top surface and a side surface and that accommodates an electrode assembly and an electrolyte solution; and a gas-release valve that releases gas from inside of the exterior package to the space through the top surface when pressure in the exterior package becomes equal to or more than a predetermined value, and the first portion faces the top surface, the battery pack further comprising a duct that is provided to face the side surface, that forms a gas flow path communicating with the space, and that discharges the gas from the space.

According to the battery pack thus configured, the gas released from the inside of the exterior package to the space through the top surface can be more securely received by the first portion disposed between the top surface and the cover. Further, the gas is discharged through the duct, thereby suppressing increased internal pressure in the space for accommodating the plurality of battery cells.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a battery pack according to an embodiment of the present invention.

FIG. 2 is an exploded assembly diagram showing the battery pack in FIG. 1.

FIG. 3 is a perspective view showing a battery cell.

FIG. 4 is a cross sectional view schematically showing the battery pack when viewed in a direction of arrow along a line IV-IV in FIG. 1.

### DESCRIPTION OF THE PREFERRED EMBODIMENTS

Embodiments of the present invention will be described with reference to figures. It should be noted that in the figures referred to below, the same or corresponding members are denoted by the same reference characters.

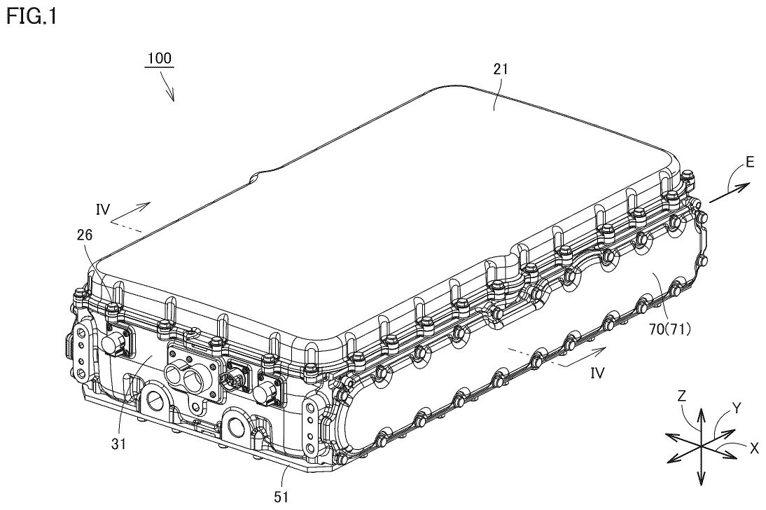

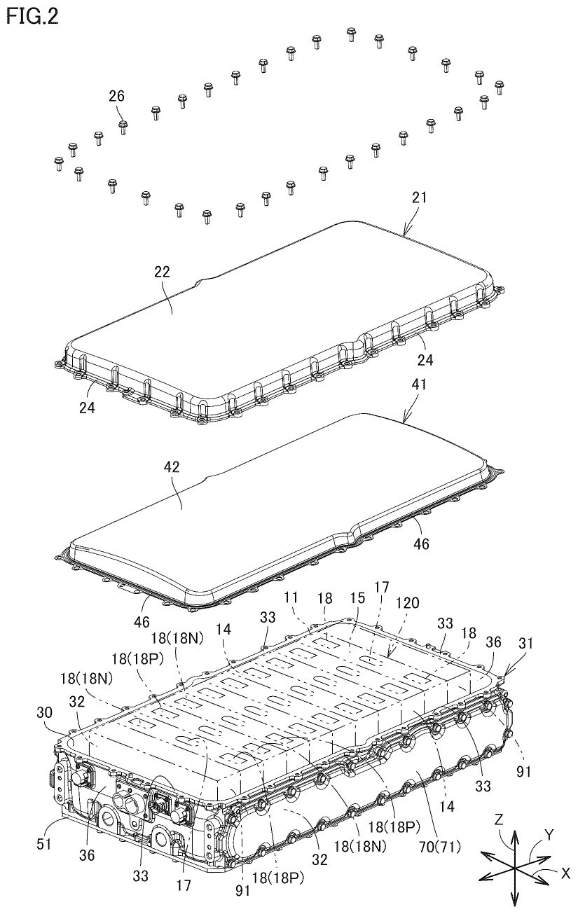

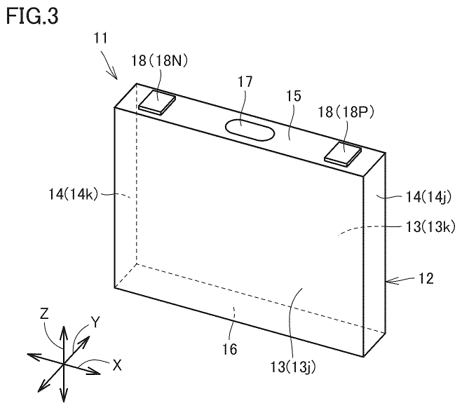

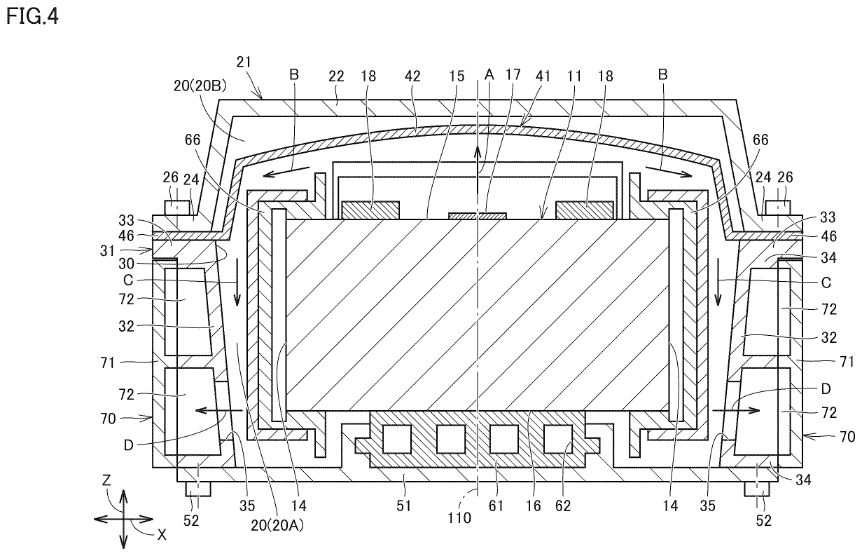

FIG. 1 is a perspective view showing a battery pack according to an embodiment of the present invention. FIG. 2 is an exploded assembly diagram showing the battery pack in FIG. 1. FIG. 3 is a perspective view showing a battery cell. FIG. 4 is a cross sectional view schematically showing the battery pack when viewed in a direction of arrow along a line IV-IV in FIG. 1.

Referring to FIGS. 1 to 4, a battery pack 100 is used as a power supply for driving a vehicle such as a hybrid electric vehicle (HEV), a plug-in hybrid electric vehicle (PHEV), or a battery electric vehicle (BEV).

In the present specification, for convenience of explanation of a structure of battery pack 100, a “Y axis” represents an axis extending in a stacking direction of a plurality of below-described battery cells 11 and in a horizontal direction, an “X axis” represents an axis extending in a direction orthogonal to the Y axis and in the horizontal direction, and a “Z axis” represents an axis extending in an upward/downward direction. As shown in FIG. 4, battery pack 100 basically has a structure symmetrical with respect to an imaginary plane 110 parallel to the Y-Z axes plane.

Battery pack 100 has a plurality of battery cells 11. The plurality of battery cells 11 are stacked in the Y axis direction. Each of battery cells 11 is constituted of a lithium ion battery. Battery cell 11 has a prismatic shape and has a thin plate shape in the form of a rectangular parallelepiped. The plurality of battery cells 11 are stacked such that the Y axis direction corresponds to the thickness direction of each battery cell 11.

Each of battery cells 11 has an exterior package 12. Exterior package 12 is constituted of a housing having a rectangular parallelepiped shape, and forms an external appearance of battery cell 11. An electrode assembly and an electrolyte solution are accommodated in exterior package 12.

Exterior package 12 has a pair of first side surfaces 14 (14j, 14k), a pair of second side surfaces 13 (13j, 13k), a top surface 15, and a bottom surface 16.

First side surfaces 14 are each constituted of a flat surface orthogonal to the X axis. First side surfaces 14 are each parallel to the Y axis direction, which is the stacking direction of battery cells 11. First side surface 14j and first side surface 14k are oriented oppositely in the X axis direction. Second side surfaces 13 are each constituted of a flat surface orthogonal to the Y axis. Each of second side surfaces 13 has the largest area among those of the plurality of side surfaces of exterior package 12. Second side surface 13j and second side surface 13k are oriented oppositely in the Y axis direction. Each of top surface 15 and bottom surface 16 is constituted of a flat surface orthogonal to the Z axis. Top surface 15 is oriented upward. Bottom surface 16 is oriented downward.

Battery cell 11 further has a gas-release valve 17. Gas-release valve 17 is provided in top surface 15. Gas-release valve 17 is provided at the central position of top surface 15 in the X axis direction. When the pressure in exterior package 12 becomes equal to or more than a predetermined value, gas-release valve 17 releases the gas from inside of exterior package 12 to outside (space 20 described later) of exterior package 12 through top surface 15.

Battery cell 11 further has electrode terminals 18 including a pair of a positive electrode terminal 18P and a negative electrode terminal 18N. Each of electrode terminals 18 is provided on top surface 15. Positive electrode terminal 18P and negative electrode terminal 18N are provided to be separated from each other in the X axis direction. Positive electrode terminal 18P and negative electrode terminal 18N are provided on both sides beside gas-release valve 17 in the X axis direction.

The plurality of battery cells 11 are stacked such that second side surfaces 13j of battery cells 11, 11 adjacent to each other in the Y axis direction face each other and second side surfaces 13k of battery cells 11, 11 adjacent to each other in the Y axis direction face each other. Thus, positive electrode terminals 18P and negative electrode terminals 18N are alternately arranged in the Y axis direction in which the plurality of battery cells 11 are stacked. Between battery cells 11, 11 adjacent to each other in the Y axis direction, positive electrode terminal 18P and negative electrode terminal 18N arranged side by side in the Y axis direction are connected to each other by a bus bar (not shown). The plurality of battery cells 11 are electrically connected to one another in series.

It should be noted that each of the battery cells of the present invention is not limited to having a prismatic shape and may have a cylindrical shape. For example, the plurality of battery cells are arranged at intervals in the X-Y axes plane with each of the battery cells being in an upright posture in which the cylindrical axis of the battery cell extends in the Z axis direction. In this case, the gas-release valve may be provided inside a sealing body included in the top surface of the battery cell.

As shown in FIG. 2, the plurality of battery cells 11 stacked in the Y axis direction form a cell stack 120. Cell stack 120 has a rectangular parallelepiped shape. The length of cell stack 120 in the Y axis direction is larger than the length of cell stack 120 in the Z axis direction and is larger than the length of cell stack 120 in the X axis direction. Cell stack 120 has a rectangular shape in which the Y axis direction corresponds to its long-side direction and the X axis direction orthogonal to the Y axis direction corresponds to its short-side direction when viewed in a plan view in the Z axis direction.

Battery pack 100 further has a pair of end plates 91 and a pair of binding bars 66 (not shown in FIG. 2 and see FIG. 4). The pair of end plates 91 are respectively disposed at both ends of cell stack 120 (the plurality of battery cells 11) in the Y axis direction. The pair of binding bars 66 are disposed at both ends of cell stack 120 in the X axis direction. Each of binding bars 66 extends in the Y axis direction and is connected to the pair of end plates 91 at both ends thereof. The plurality of battery cells 11 are collectively held by the pair of end plates 91 and the pair of binding bars 66.

Battery pack 100 further has a case main body 31 and a cover 21. Each of case main body 31 and cover 21 is composed of a metal. Each of case main body 31 and cover 21 is composed of aluminum, for example. Case main body 31 is provided with an opening 30. Opening 30 is opened upward. Cover 21 is attached to case main body 31 so as to close opening 30. Cover 21 forms, together with case main body 31, a space 20 for accommodating the plurality of battery cells 11.

Case main body 31 has a bottom portion 51, a pair of first side portions 32, and a pair of second side portions 36. Bottom portion 51 has a wall shape in which bottom portion 51 is disposed along the X-Y axes plane with the Z axis direction corresponding to its thickness direction. Bottom portion 51 has a rectangular shape when viewed in a plan view in the Z axis direction. Cell stack 120 is placed on bottom portion 51. A cooling plate 61 is interposed between bottom portion 51 and cell stack 120. Cooling plate 61 is provided with a coolant path 62 extending in the Y axis direction.

The pair of first side portions 32 and the pair of second side portions 36 rise from the peripheral edge of bottom portion 51. The pair of first side portions 32 face each other in the X axis direction with space 20 being interposed therebetween. Each of first side portions 32 has a wall shape in which first side portion 32 is disposed along the Y-Z axes plane with the X axis direction corresponding to its thickness direction. The pair of second side portions 36 face each other in the Y axis direction with space 20 being interposed therebetween. Each of second side portions 36 has a wall shape in which second side portion 36 is disposed along the X-Z axes plane with the Y axis direction corresponding to its thickness direction.

Bottom portion 51 is fastened to the pair of first side portions 32 and the pair of second side portions 36 using a plurality of bolts 52. It is not limited to such a configuration, and bottom portion 51, the pair of first side portions 32, and the pair of second side portions 36 may be integrally formed from a metal.

Space 20 is formed at a position located above bottom portion 51 and surrounded by the pair of first side portions 32 and the pair of second side portions 36. Opening 30 is defined by the upper end portions of the pair of first side portions 32 and the pair of second side portions 36. Space 20 is opened to a space outside case main body 31 through opening 30.

Case main body 31 further has a first flange portion 33. First flange portion 33 extends in the form of a flange from the upper end portions of the pair of first side portions 32 and the pair of second side portions 36 in plane directions of the X-Y axes plane. First flange portion 33 is provided in the form of a frame along the upper end portions of the pair of first side portions 32 and the pair of second side portions 36.

Cover 21 has a cover main body portion 22 and a second flange portion 24. Cover main body portion 22 constitutes a main portion of cover 21, and closes opening 30. Cover main body portion 22 has a receiving pan shape so as to be opened downward with the Z axis direction corresponding to its depth direction. Second flange portion 24 extends in the form of a flange from the lower end portion of cover main body portion 22 in the plane directions of the X-Y axes plane. Second flange portion 24 is provided in the form of a frame along the lower end portion of cover main body portion 22. Second flange portion 24 overlaps with first flange portion 33 in the Z axis direction. Cover 21 is attached to case main body 31 by fastening first flange portion 33 and second flange portion 24 to each other using a plurality of bolts 26.

Battery pack 100 further has a plate member 41. Plate member 41 is composed of a material having heat resistance to such an extent that the material is not deformed even when exposed to high-temperature gas or flame generated from battery cell 11, and is preferably composed of a metal or ceramic. For example, plate member 41 is composed of a metal such as carbon steel, stainless steel, copper, aluminum, or titanium, or is composed of a ceramic such as alumina, zirconia, or silica. Plate member 41 may be formed by coating a surface of each of the materials with a resin material. The thickness of plate member 41 is smaller than the thickness of cover 21.

Plate member 41 has a first portion 42 and a second portion 46. First portion 42 and second portion 46 are integrally formed from the metal or ceramic. First portion 42 and second portion 46 are connected to each other continuously. The material of first portion 42 and the material of second portion 46 are the same. The thickness of first portion 42 and the thickness of second portion 46 are the same.

First portion 42 is provided in space 20. First portion 42 is disposed between each of the plurality of battery cells 11 and cover 21 in space 20. First portion 42 is disposed between cell stack 120 and cover main body portion 22 in space 20. First portion 42 faces top surfaces 15 of battery cells 11 in the Z axis direction. First portion 42 faces gas-release valves 17 in the Z axis direction. First portion 42 faces electrode terminals 18 (positive electrode terminals 18P and negative electrode terminals 18N) in the Z axis direction.

First portion 42 has a receiving pan shape so as to be opened downward with the Z axis direction corresponding to its depth direction. First portion 42 has a rectangular shape in which the Y axis direction corresponds to its long-side direction and the X axis direction orthogonal to the Y axis direction corresponds to its short-side direction when viewed in a plan view in the Z axis direction. A range of cell stack 120 when viewed in a plan view in the Z axis direction is included in the range of first portion 42 when viewed in a plan view in the Z axis direction.

Second portion 46 is provided at a peripheral edge of first portion 42. Second portion 46 is provided along the peripheral edge of first portion 42 when viewed in a plan view in the Z axis direction. Second portion 46 extends in the form of a flange from the lower end portion of first portion 42 in the plane directions of the X-Y axes plane. Second portion 46 is provided in the form of a frame along the lower end portion of first portion 42.

Second portion 46 is sandwiched by case main body 31 and cover 21. Second portion 46 is interposed between first flange portion 33 and second flange portion 24. Second portion 46 receives fastening force by the plurality of bolts 26 between first flange portion 33 and second flange portion 24.

Space 20 is partitioned into a space 20A and a space 20B by plate member 41. Space 20B is surrounded by plate member 41 and cover 21. Space 20A is surrounded by plate member 41 and case main body 31. The plurality of battery cells 11 are accommodated in space 20A.

Battery pack 100 further has a duct 70. Duct 70 is provided to face first side surface 14 of battery cell 11. Duct 70 forms a gas flow path 72. Gas flow path 72 communicates with space 20. Duct 70 discharges, from space 20, gas released from gas-release valve 17.

Case main body 31 further includes a rib portion 34. Rib portion 34 protrudes from first side portion 32 in the X axis direction, and extends in the form of a rib along the peripheral edge of first side portion 32. Duct 70 has a pair of duct covers 71. The pair of duct covers 71 are attached to the pair of first side portions 32, respectively. Each of duct covers 71 is attached to first side portion 32 so as to come into abutment with rib portion 34 in the X axis direction.

Duct cover 71 forms a gas flow path 72 together with first side portion 32. A gas flow hole 35 is provided in first side portion 32. Gas flow hole 35 is constituted of a hole extending through first side portion 32, and communicates space 20 (20A) with gas flow path 72. Gas flow path 72 extends in the Y axis direction and is opened at one end portion thereof.

It is assumed that combustible gas is generated inside exterior package 12 in response to occurrence of a battery abnormality such as an internal short circuit in battery cell 11. The gas is discharged into space 20 (20A) through top surface 15 provided with gas-release valve 17 (gas flow indicated by an arrow A in FIG. 4). The gas hits plate member 41, is guided by first portion 42 to flow from the central portion of space 20 (20A) toward both end portions thereof in the X axis direction, and further flows downward through a clearance between cell stack 120 and each first side portion 32 (gas flow indicated by each of arrows B and C in FIG. 4). The gas is discharged from space 20 (20A) to gas flow path 72 through gas flow hole 35 (gas flow indicated by an arrow D in FIG. 4). The gas flows through gas flow path 72 in the Y axis direction and is discharged to the outside of duct 70 (gas flow indicated by an arrow E in FIG. 1).

In response to an increase in capacity of the battery in recent years, an amount of gas generated in battery cell 11 is increased. For this reason, high-pressure gas may be jetted from battery cell 11, or the gas may be increased in pressure to have a high temperature to result in spontaneous ignition. In preparation for such a case, battery pack 100 according to the present embodiment is provided with plate member 41 having first portion 42 and second portion 46.

In space 20, first portion 42 disposed between each of the plurality of battery cells 11 (cell stack 120) and cover 21 receives the high-pressure gas jetted from battery cell 11 or a shock wave caused by the spontaneous ignition, thereby preventing cover 21 from being damaged. In addition, first portion 42 also has a heat shielding function to prevent cover 21 from being exposed to the high-temperature gas. Further, by second portion 46 sandwiched by case main body 31 and cover 21, the gas can be prevented from being leaked from a portion other than the gas-discharge path. Since first portion 42 and second portion 46 are provided integrally in plate member 41 in such a configuration, the configuration of battery pack 100 can be simplified.

Further, in the present embodiment, since first portion 42 is disposed between cover 21 and top surface 15 provided with gas-release valve 17, the high-pressure gas released from gas-release valve 17 can be more securely received by first portion 42.

Summarizing the above-described structure of battery pack 100 according to the embodiment of the present invention, battery pack 100 according to the present embodiment includes: the plurality of battery cells 11; case main body 31 provided with opening 30; cover 21 that is attached to case main body 31 so as to close opening 30 and that forms, together with case main body 31, space 20 for accommodating the plurality of battery cells 11; and plate member 41 having first portion 42 and second portion 46, first portion 42 being disposed between each of the plurality of battery cells 11 and cover 21 in space 20, second portion 46 being disposed at the peripheral edge of first portion 42, second portion 46 being sandwiched by case main body 31 and cover 21, plate member 41 being composed of a metal or ceramic.

According to battery pack 100 thus configured in the embodiment of the present invention, with the simple configuration, leakage of the gas from space 20 can be prevented while preventing damage of cover 21.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A battery pack comprising:
a plurality of battery cells;
a case main body provided with an opening;
a cover that is attached to the case main body so as to close the opening and that forms, together with the case main body, a space for accommodating the plurality of battery cells; and
a plate member having a first portion and a second portion, the first portion being disposed between each of the plurality of battery cells and the cover in the space, the second portion being provided at a peripheral edge of the first portion, the second portion being sandwiched by the case main body and the cover, the plate member being composed of a metal or ceramic.

2. The battery pack according to claim 1, wherein
each of the battery cells has
an exterior package that includes a top surface and a side surface and that accommodates an electrode assembly and an electrolyte solution, and
a gas-release valve that releases gas from inside of the exterior package to the space through the top surface when pressure in the exterior package becomes equal to or more than a predetermined value, and
the first portion faces the top surface,
the battery pack further comprising a duct that is provided to face the side surface, that forms a gas flow path communicating with the space, and that discharges the gas from the space.
